(19) United States
(12) Patent Application Publication
(10) Pub. No.: US 2022/0253148 A1
(43) Pub. Date: Aug. 11, 2022

(54) Devices, Systems, and Methods for Contactless Interfacing

(71) Applicant: PepsiCo, Inc., Purchase, NY (US)

(72) Inventors: Mia C. SORGI, London (GB); Stuart GEORGE, London (GB); Athina KANIOURA, London (GB); Jacob LIETZ, New York, NY (US); Daniel ROBSON, London (GB); Felix ROS, London (GB); David B. SCHWARTZ, Tel Aviv (IL); Jessica L. N. SOULA, London (GB); Olivia J. ZHOU, London (GB)

(21) Appl. No.: 17/665,264

(22) Filed: Feb. 4, 2022

Related U.S. Application Data
(60) Provisional application No. 63/146,195, filed on Feb. 5, 2021.
(60) Provisional application No. 63/281,112, filed on Nov. 19, 2021.

(51) Int. Cl. G06F 3/01; G06F 3/04842; G06F 3/0346; G06Q 30/06

(52) U.S. Cl. CPC G06F 3/017; G06Q 30/0641; G06F 3/0346; G06F 3/04842

(57) ABSTRACT

Devices, systems, and methods for contactless user interfacing can include applying a user interface display configured for presenting at least visual information to the user, a sensor system for capturing contactless user inputs, the sensor system being configured to detect penetration of an activation zone by the user's hands as an indication that the user intends to provide contactless user input to the user interface display, the sensor system being configured for direct tracking of a user's hand to directly sense the position of the user's hands in at least a portion of an area outside from the activation zone, and a control system arranged in communication with the sensor system to receive the user input signal and configured to determine a target interface element engaged by the user for contactless activation of the visual information, based on indication of direct tracking of the user's hands and indication of penetration of the activation zone of the user input signal.

### CROSS-REFERENCE

This Utility Patent Application claims the benefit of priority to each of Provisional Application No. 63/146,195, filed on Feb. 5, 2021, entitled “DEVICES, SYSTEMS, AND METHODS FOR CONTACTLESS INTERFACING”, and Provisional Application No. 63/281,112, filed on Nov. 19, 2021, entitled “TIMING/MEASUREMENT/VR DEVICES, SYSTEMS, AND METHODS FOR CONTACTLESS INTERFACING,” the contents of each of which are hereby incorporated by reference in their entireties, including but without limitation, those portions related to interfacing.

### FIELD

The present disclosure relates to devices, systems, and methods for contactless user interfacing and more particularly to devices, systems, and methods for contactless interfacing for user self-help.

### SUMMARY

According to an aspect of the present disclosure, a contactless user interface system for ordering merchandise without user contact with peripherals may include a user interface display configured for presenting visual information to the user, the visual information comprising at least one selectable merchandise option; and a sensor system for capturing contactless user inputs, the sensor system comprising at least one sensor configured to capture contactless user inputs including user position and user contactless gesture, the sensor system configured to detect penetration of an activation zone as an indication that the user intends to provide contactless user input to the user interface display, wherein the sensor system is configured for direct tracking of a user's hand to directly sense the position of the user's hand in at least a portion of an area outside from the activation zone, wherein the sensor system is configured to communicate one or more user input signals indicating direct tracking of the user's hand and indicating the detected penetration of the activation zone. The contactless user interface system may include a control system including a processor configured to execute instructions stored on memory to govern contactless user interface system operations. The control system may be arranged in communication with the sensor system to receive the one or more user input signals and configured to determine a target interface element applied by the user for contactless engagement with the visual information of the user interface display, based on indication of direct tracking of the user's hand and indication of penetration of the activation zone of the one or more user input signals.

In some embodiments, the control system may be configured to define the activation zone as a region ahead of the user interface display extending beyond a face of the user interface display by a predetermined distance. The activation zone may be defined by the control system for enhanced monitoring to determine a focal point of the target interface element, wherein the focal point of target interface element may be applied as a precise point of indication for user contactless activation of visual information.

In some embodiments, the focal point of the target interface element may include a point of the user's hand, or of an instrument held in the user's hand, that is closest to the user interface display within the activation zone as the precise point of indication for user contactless engagement with the visual information. The control system may be configured to define the activation zone as a 3-dimensional region. In some embodiments, the control system may be configured to define the activation zone as a region projecting farther from the user interface display near at least one of a top section and a bottom section of the user interface display than in a mid-section of the display.

In some embodiments, the control system may configured to determine an acceleration of the user's hand or instrument held in the user's hand within the activation zone based on the one or more user input signals. The control system may be configured to determine user intent to cause activation of visual information of the user interface display based on the determined acceleration within the activation zone. The control system may be configured to determine user intent to cause activation of an area on the user interface display by comparison of the determined acceleration within the activation zone with a predetermined threshold acceleration. The control system may be configured to determine the predetermined threshold acceleration based on at least one of penetration of the activation zone and direct tracking of the user's hand based on the user input signal.

In some embodiments, penetration of the user's hand within the activation zone may include at least one of depth of penetration into the activation zone and a hand configuration of the user. The hand configuration of the user may include the number of fingers of the user's hand extended to indicate the visual information for activation on the user interface display. In some embodiments, depth of penetration may include distance between the user interface display and a lead digit of the user's hand. In some embodiments, the control system may be configured to determine that the lead digit of the user's hand is the closest finger to the user interface display. In some embodiments, the control system may be configured to determine that the lead digit of the user's hand is the not closest finger to the user interface display, based on the user's hand configuration within the activation zone.

In some embodiments, the control system may be configured to define the activation zone based on information gathered by the sensor system regarding the user. The control system may be configured to actively define the activation zone. The control system may be configured to actively define the activation zone based on information gathered by the sensor system regarding the user.

According to another aspect of the present disclosure, a method of contactless user interfacing for ordering merchandise without user contact with peripherals may include presenting visual information to a user via a user interface display, the visual information comprising at least one selectable merchandise option; and capturing contactless user inputs including user position and user contactless gesture, via a sensor system, wherein capturing contactless user inputs includes detecting penetration of an activation zone as an indication that the user intends to provide contactless user input to the user interface display, and directly tracking a user's hand to directly sense the position of the user's hand in at least a portion of an area outside from the activation zone, and communicating one or more user input signals indicating direct tracking of the user's hand and indicating the detected penetration of the activation zone. The methods may include determining, via a control system, a target interface element applied by the user for contactless engagement with the visual information of the user interface display, based on indication of direct tracking of the user's hand and indication of penetration of the activation zone of the one or more user input signals.

In some embodiments, capturing contactless gestures may include defining the activation zone as a region ahead of the user interface display extending beyond a face of the user interface display by a predetermined distance. The activation zone may be defined by the control system for enhanced monitoring to determine a focal point of the target interface element, wherein the focal point of target interface element may be applied as a precise point of indication for user contactless activation of visual information. The focal point of the target interface element may include a point of the user's hand, or of an instrument held in the user's hand, that is closest to the user interface display within the activation zone as the precise point of indication for user contactless engagement with the visual information.

In some embodiments, the activation zone may be defined as a 3-dimensional region. In some embodiments, defining the activation zone may include defining a region projecting farther from the user interface display near at least one of a top section and a bottom section of the user interface display than in a mid-section of the display.

In some embodiments, determining a target selection device may include determining an acceleration of the user's hand or instrument held in the user's hand within the activation zone based on the one or more user input signals. Determining a target selection device may include determining user intent to cause activation of visual information of the user interface display based on the determined acceleration within the activation zone. Determining user intent to cause activation may include determining intent to cause activation of an area on the user interface display by comparison of the determined acceleration within the activation zone with a predetermined threshold acceleration.

In some embodiments, determining intent to cause activation may include determining the predetermined threshold acceleration based on at least one of penetration of the activation zone and direct tracking of the user's hand based on the user input signal. In some embodiments, penetration of the user's hand within the activation zone may include at least one of depth of penetration into the activation zone and a hand configuration of the user. In some embodiments, the hand configuration of the user may include the number of fingers of the user's hand extended to indicate the visual information for activation on the user interface display.

In some embodiments, depth of penetration may include distance between the user interface display and a lead digit of the user's hand. In some embodiments, determining a target selection device may include determining that the lead digit of the user's hand is the closest finger to the user interface display. In some embodiments, determining a target selection device may include determining that the lead digit of the user's hand is the not closest finger to the user interface display, based on the user's hand configuration within the activation zone.

In some embodiments, capturing contactless gestures includes defining the activation zone based on information gathered by the sensor system regarding the user. In some embodiments, defining the activation zone may include actively define the activation zone. In some embodiments, actively defining the activation zone may include actively defining the activation zone based on information gathered by the sensor system regarding the user.

According to another aspect of the present disclosure, a contactless user interface system for selecting merchandise without user contact with peripherals may include a user interface display configured for presenting visual information to the user, the visual information comprising at least one selectable merchandise option; a sensor system for capturing contactless user inputs, the sensor system comprising at least one sensor configured to capture contactless user inputs including user position and user contactless gesture; and a control system. The control system may include a processor configured to execute instructions stored on memory to govern contactless user interface system operations, the control system arranged in communication with the sensor system to receive the one or more user input signals for determining user inputs as commands.

In some embodiments, the control system may be configured to determine which fingertip of a user's hand is furthest removed from the center of the palm of the corresponding hand, and to identify the determined fingertip as a target interface element. In response to capture of multiple user hands close in time with each other by the sensor system, the control system may be configured to determine which one of the multiple user hands corresponds with a determined fingertip that is closest to the user interface display. In response to determination that one determined fingertip of one corresponding hand is the closest to the user interface display of multiple hands, the control system may be configured to designate the one determined fingertip as the primary target interface element.

In some embodiments, in response to determination that another determined fingertip of one corresponding hand is newly the closest to the user interface display of multiple hands, the control system may be configured to re-designate the another determined fingertip as the primary target interface element. Re-designation may be undertaken only after at least a predetermined time pause from a previous designation. Activation of a command by a primary target interface element may be undertaken only after a predetermined time pause from a previous command to avoid unintended activations. Activation of a command by a primary target interface element of a corresponding hand may be undertaken only after a predetermined time pause from a previous command to avoid unintended activations from the same corresponding hand. Activation of a command by a primary target interface element of another corresponding hand that is re-designated may be undertaken without the predetermined time pause.

In some embodiments, activation of a command by a primary target interface element of a corresponding hand may be undertaken only after a predetermined time pause from a previous command to avoid unintended activations from the same corresponding hand. Activation of a command by a primary target interface element of another corresponding hand that is re-designated may be undertaken without the predetermined time pause. In some embodiments, the contactless user interface system may be implemented as a portion of a virtual kiosk.

According to another aspect of the present disclosure, a virtual kiosk may include a contactless user interface system for selecting merchandise without user contact with peripherals, the system comprising: a user interface display configured for presenting virtual visual information to the user, the virtual visual information comprising at least one selectable merchandise option; a sensor system for capturing contactless user inputs, the sensor system comprising at least one sensor configured to capture contactless user inputs including user position and user contactless gesture, the sensor system configured to detect penetration of an activation zone as an indication that the user intends to provide contactless user input to the user interface display, wherein the sensor system is configured for direct tracking of a user's hand to directly sense the position of the user's hand in at least a portion of an area outside from the activation zone, wherein the sensor system is configured to communicate one or more user input signals indicating direct tracking of the user's hand and indicating the detected penetration of the activation zone; and a control system. The control system may include a processor configured to execute instructions stored on memory to govern contactless user interface system operations, the control system arranged in communication with the sensor system to receive the one or more user input signals and configured to determine a target interface element applied by the user for contactless engagement with the visual information of the user interface display, based on indication of direct tracking of the user's hand and indication of penetration of the activation zone of the one or more user input signals.

In some embodiments, the activation zone may be defined as a virtual zone. The activation zone may be defined as a physical zone. The user's hand may be defined as a virtual hand. The user's hand may be defined as a physical hand. In some embodiments, at least one of the sensor system and the control system may be a virtual system. At least one of the sensor system and the control system may be a physical system. In some embodiments, the user interface display may be a virtual display. The user interface display may be a physical display.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

The detailed description particularly refers to the accompanying figures in which:

FIG. 1 is perspective view of a user addressing a contactless user interface;

FIG. 2 is a diagrammatic elevation view of a user addressing the contactless user interface of FIG. 1, indicating an activation zone for enhanced consideration of the user's position;

FIG. 3 is a diagrammatic elevation view of a user addressing the contactless user interface as in FIG. 2, indicating a number of fields by which the activation zone of FIG. 2 can be defined;

FIGS. 4-7 are each a perspective view of a user addressing a contactless user interface as in FIG. 1, using a different hand configuration in each instance;

FIG. 8 is a diagrammatic elevation view of a user addressing the contactless user interface as in FIGS. 2 and 3, showing that the contactless user interface includes a holographic projector;

FIG. 9 is a perspective view of the contactless user interface system of FIG. 1 configured for use in a drive through arrangement;

FIG. 10 is a flow diagram indicating operations for determining user activation of visual information of a display of the contactless user interface of FIG. 1;

FIG. 11 is a flow diagram indicating operations for defining the activation zone of the contactless user interface of FIGS. 1; and

FIG. 12 is a diagrammatic view of a control system of the contactless user interface of FIG. 1.

### DETAILED DESCRIPTION

While the concepts of the present disclosure are susceptible to various modifications and alternative forms, specific embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

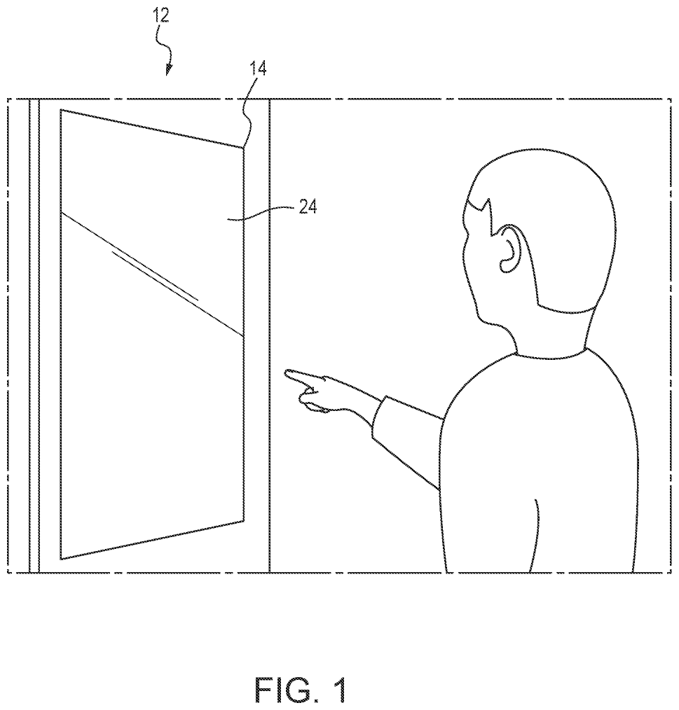

Referring to FIG. 1, a generic illustration of touchless or contactless user interfacing is shown to include a user interface system 12 including a user interface display 14 being addressed by a user. The display 14 is generally embodied as a visual screen display for displaying text and/or images. The user is illustratively communicating user inputs to the user interface system 12 by contactless gesture, i.e., without actually touching the display 14. The user may conduct traditional interface operations such as selecting icons, navigating content, and/or otherwise interacting with the user interface system 12 without the need for contacting the display 14.

In the exemplary depiction of FIG. 1, the user is positioned in front of the display 14. For example, the user has entered a restaurant and approaches the contactless user interface system 12 to place an order for food and beverage. The display 14 is illustratively oriented for user interfacing while the user is standing, positioned generally within the comfortable range of reach for most individuals. However, teaching a user that the user interface system 12 is a contactless system which should not be touched for interfacing is challenging.

Users are often familiar with touchscreen displays, such as touchscreens displays for tablets, smartphones, or touchscreen kiosks, but may have limited experience with contactless user interfacing. Users often will presume that display screens require touching, and have difficulties receiving baseline instructions about how to interface with a display without prior experience or in-person instruction. For example, attempts to use physical signage near the display and even instructional videos are often overlooked or ignored by users.

Additionally, users may find it difficult to learn new techniques for interfacing. If a user is familiar with swipe gestures for scrolling pages, teaching another type of gesture for scrolling pages can be challenging, particularly in the context of the relatively brief time period expected for kiosk interaction. Frustration can occur rather quickly if user expectations for the time required to interact with the display are exceeded. Thus, a balance is required between user expectations and the amount of training required for the user to conduct basic interfacing. Accordingly, it can be understood that introduction of contactless interfacing to users traditionally familiar with touchscreens can be challenging. Achieving an intuitive, yet sensitive contactless interface experience can require consideration of these challenges.

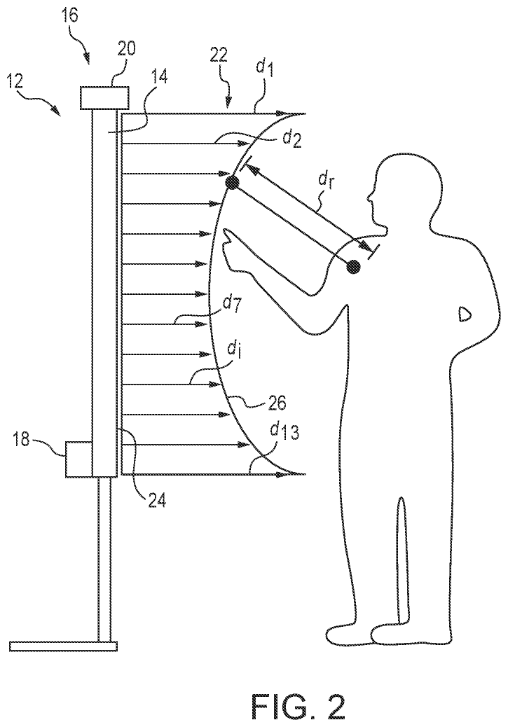

Referring now to FIG. 2, the contactless user interface system 12 is shown embodied as a kiosk for a quick service restaurant. The system 12 includes the display 14, a sensor system 16, and a control system 18 for conducting user interface operations. The sensor system 16 and control system 18 are arranged in communication with each other to provide interactive user interfacing via the display 14, as discussed in additional detail herein.

The sensor system 16 includes a sensor 20 for capturing contactless user inputs. The sensor 20 is illustratively embodied as a camera arranged to capture the user's hand location and movements. In the illustrative embodiment, the sensor 20 is configured for direct hand tracking to directly sense the position of the user's hand(s). One non-exhaustive example of a suitable device for use as sensor 20 may include the Leap Motion Controller as marketed by Ultra Leap of Mountain View, California. In the illustrative embodiment, the sensor 20 is configured for image capture and analysis including within the visible spectrum and/or the non-visible spectrum (e.g., infrared, ultraviolet, microwave, x-ray). In some embodiments, the sensor 20 may comprise non-image based sensing such as by radar, lidar, and/or sonar. In some embodiments, the sensor 20 may capture location and/or movements beyond the user's hand, for example, the user's wrists, arms, torso, etc. In the illustrative embodiment, the camera 20 is arranged above the display 14 (and above the user), but in some embodiments, may have any suitable position for capturing contactless user inputs.

In FIG. 2, an activation zone 22 is defined for determining user inputs to the user interface system 12. As discussed in additional detail herein, the activation zone 22 represents a defined zone for enhanced sensitivity in determining the user's hand position and/or activity to determine user intent in interfacing. The control system 18 is configured to determine target display elements of the display 14 with which the user intends to interact, based on direct tracking of the user's hand and based on penetration of the activation zone.

In the illustrative embodiment, the activation zone 22 is defined as a region in front of the display 14 that is within the user's reach for gesture (i.e., not specifically requiring actual reach to touch the display 14). The control system 18 can define the activation zone 22 as a region extending beyond a face 24 of the display 14. As suggested in FIG. 2, the activation zone 22 includes a forward face 26 defined by predetermined spacing from the face 24 of the display 14. The predetermined spacing is illustratively defined by predetermined projected distance(s) dᵢ from the face 24.

In the illustrative embodiment as shown in FIG. 2, the activation zone 22 is defined with the forward face 26 having curvature. Namely, upper and lower regions of the activation zone 22 are illustratively defined by greater projected distances d₁, d₂, d₁₃ than the projected distance d₇ defining a mid-region of the activation zone 22. The curvature of the activation zone 22 can increase the accuracy and/or precision of contactless user input by adapting the area of focus for consideration in determining the user's intended input.

For example, it has been observed that users tend to be less definitive in their gestures near the top and/or bottom regions of the display. Manifestation of such issues can take various forms but can include the user providing lesser extent of motion in the region, providing lesser dwell time within the area of interest, and/or providing generally less emphatic gestures. These challenges can be at least partly attributed to the user's reach, for example, the comfortable reach distance dᵣ between the user's shoulder and the user's intended target selection element (e.g., pointing finger). Although the reach distance dᵣ is indicated by a straight line in FIG. 2, the reach distance dᵣ may be different depending on the particular area of the display 14 which the user is addressing, e.g., side to side, up or down. The curvature of the activation zone 22 can assist in accommodating the reduced definition of the user's gestures by conforming the proximity of the activation zone 22 with the comfortable reach of the user.

The control system 18 may, additionally or alternatively, define the activation zone 22 actively based on the user. For example, the control system 18 may actively determine the predetermined spacing of the activation zone 22 based on the individual user. The sensor 20 can capture information about the user for communication to the control system 18. The control system 18 determines the predetermined projected distance(s) d₁ based on the information about the user. Information about the user may include geometries and/or movements which indicate the user's comfortable range of motion, for example, height, stance, gait, arm length, hand dominance, posture, mobility limitations (e.g., cane, wheelchair, etc.), and/or other suitable aspects considering the user's reach.

Although the activation zone 22 is illustratively defined having symmetry in the vertical direction in FIG. 2 (symmetry along the horizontal axis) such that d₁ is similar to d₁₃, the activation zone 22 may be formed such that curvature of the face 26 has non-symmetric form. For example, the lower region of the activation zone 22 can be particularly disregarded by users such that less definitive gestures are used while the upper region of the activation zone 22 may simply be more burdensome to reach, although some users will have different experiences. Accordingly, the upper and lower regions of the activation zone 22 may be defined to have different projected distances dᵢ from each other. As mentioned above, the control system 18 can determine each of the desired predetermined projected distances dᵢ to form the face 26 of the activation zone 22 to accommodate the particular user.

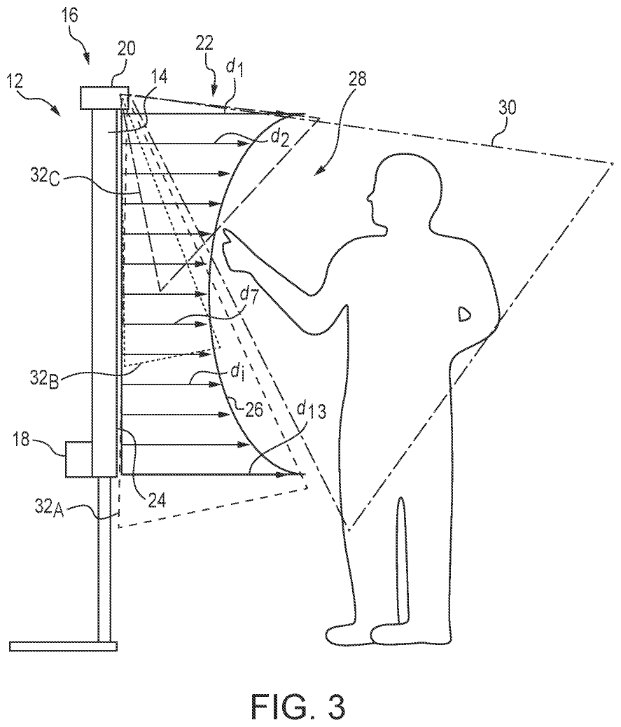

Referring now to FIG. 3, the activation zone 22 is illustratively defined by the control system 18 as a region of enhanced sensitivity to the user's hand and/or gesture activities. The sensor system 16 is illustratively arranged at the top of the display 14 to capture information regarding the activation zone 22 and areas 28 beyond the activation zone 22. As mentioned above, the sensor system 16 performs direct hand tracking to provide real-time direct monitoring of the user's hand position and/or movements. In the areas 28 beyond the activation zone 22, direct hand tracking can assist in contactless interfacing, for example, by determining a reliable course of hand tracking even before the user presents an activation gesture. Such direct hand tracking can provide baseline and/or complimentary data for consideration with data from the activation zone 22 from which the control system 18 can determine a target interface element of the display 14 engaged by the user for contactless activation of visual information.

Referring still to the illustrative embodiment of FIG. 3, the sensor system 16 provides a field of view for capturing information regarding the user's hand position and movements. The field of view of the sensor system 16 comprises a number of sub-fields for illustrating operations of the contactless interfacing system 12. The field of view of the sensor system 16 comprises one or more direct subfields 30 for direct hand tracking, including for the areas 28 beyond the activation zone 22. Although the direct subfield 30 may overlap with some or all of the activation zone 22, the direct subfield 30 is intended to illustrate data gathering to support direct hand tracking. For example, in the exemplary use of one or more cameras as sensors 20, the direct subfield 30 can represent the principal area of visual range for the sensor system 16 to provide direct hand tracking. In the illustrative embodiment, the direct subfield 30 is shown as a semi-conical line of sight directed principally onto the area 28 beyond the activation zone 22, but in some embodiments, may have any suitable shape and/or principal direction for assisting the control system 18 in determining user interfacing.

The field of view of the sensor system 16 comprises one or more activation subfields 32ᵢ for defining of the activation zone 22. The activation subfields 32ᵢ include subfields 32A-c. The activation subfields 32_{A-C} are illustratively directed to specific areas of the region for occupation of the activation zone 22. Each activation subfield 32_{A-C} is illustratively directed to a different region of the activation zone 22 to provide complete coverage definition of the activation zone 22. In the illustrative embodiment as shown in FIG. 3, the activation subfield 32_{A} is generally directed to a lower region of the activation zone 22. The activation subfield 32_{B} is generally directed to a mid-region of the activation zone 22. The activation subfield 32c is generally directed to an upper region of the activation zone 22. The activation subfields, although being generally directed to different regions of the activation zone 22, have some extent of overlap with each other, however, in some embodiments, some activation subfields 32ᵢ may have no overlap with other activation subfields 32ᵢ. Although three activation subfields 32ᵢ have been disclosed for convenience in description, any suitable number of activation subfields may be applied, including multiple subfields which may have the same or similar general directions for enhanced scrutiny in determining user hand positions and/or gestures within the activation zone 22.

The control system 18 can apply the activation subfields 32ᵢ to define the activation zone 22. The control system 18 can define the activation zone 22 as a region of enhanced scrutiny for determining user hand positions and/or gestures. In the illustrative embodiment, the sensor 20 includes a camera capturing image data, and the control system 18 applies an enhanced rate of computational analysis to the image data within the activation zone 22. For example, the control system 18 can apply multiple times the processing power to computational image analysis for the image data within the activation zone 22. As user hand positions and/or gestures are relatively quick, and change in real-time, enhancing the computational resources applied to the precise activation zone 22 can be applied to more intensely consider the image information in the focused area of the activation zone 22. This can enhance accuracy, precision, and/or speed of determination of the user's actual hand position and/or movements from which contactless interfacing can be achieved. In some embodiments, the control system 18 may provide enhanced scrutiny to data from the activation zone 22 by analyzing such data differently from data in direct hand tracking, for example, by different techniques for edge finding, body skeletal tracking, and/or even applying multiple different techniques in parallel to the data from the activation zone 22.

In particular, the control system 18 in defining the activation zone 22 can determine the user's hand configuration with enhanced reliability. Determining the user's hand configuration includes determining the shape of the user's hand position for determining the intended focal point, as the target interface element, for interfacing with the display 14. The intended focal point is generally discussed herein as being a point of the user's hand, but may also include instruments such as a stylus or other object being held by the user.

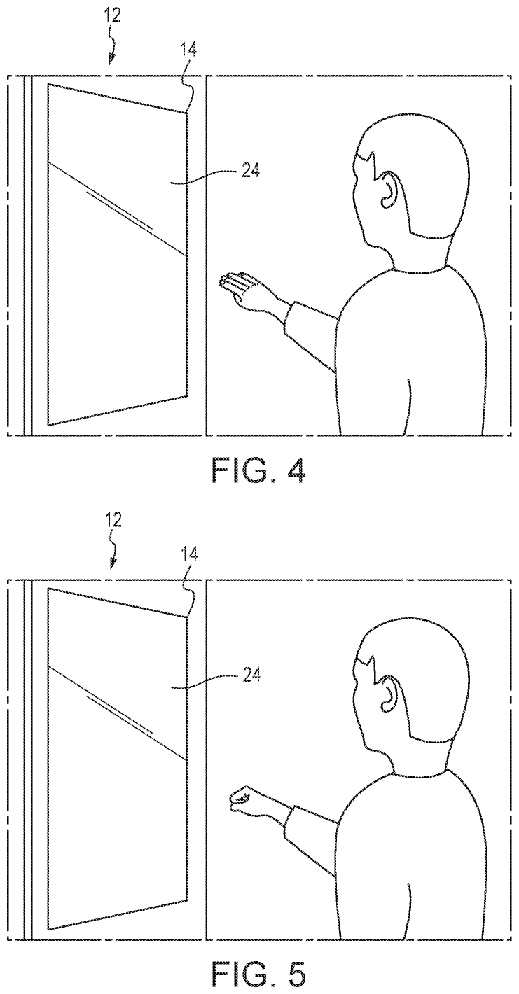

Referring to FIGS. 4-8, users interacting with contactless user interface systems 12 may use a wide variety of techniques to address the display 14. Returning briefly to FIG. 1, the user has elected to address the display 14 using a pointed index finger as the target interface element for interaction with the display 14. Although using the index finger may be common, and may indeed be the most common way users choose to address the display 14, users often adopt other techniques.

For example, as suggested in FIG. 4, the user has elected to address the display 14 using four fingers (not the thumb) of the right hand, fully extended and directed to the display 14. As an example of the challenges and variety that can be encountered, the close proximity of the user's four fingers, the length and shape of the user's fingers, and/or even the position of the user's body and/or arm may impact the determination of which specific point on the user's hand the user actually intends as the precise point of interfacing. For example, the user may user the four fingers in pointing, but may actually intend only the middle finger, or even a central point between the middle finger and ring finger as the precise point of the user's hand intended as the target interface element for interaction with the display 14. Such uncertainties about the target interface element can cause inconsistencies and/or inaccuracies in contactless interfacing as the system 12 might fail to recognize the precise point intended by the user for interaction. This recognition problem can itself be driven by inexperience of the user in contactless interfacing where the user may not appreciate the sensitivity of the user interface system 12.

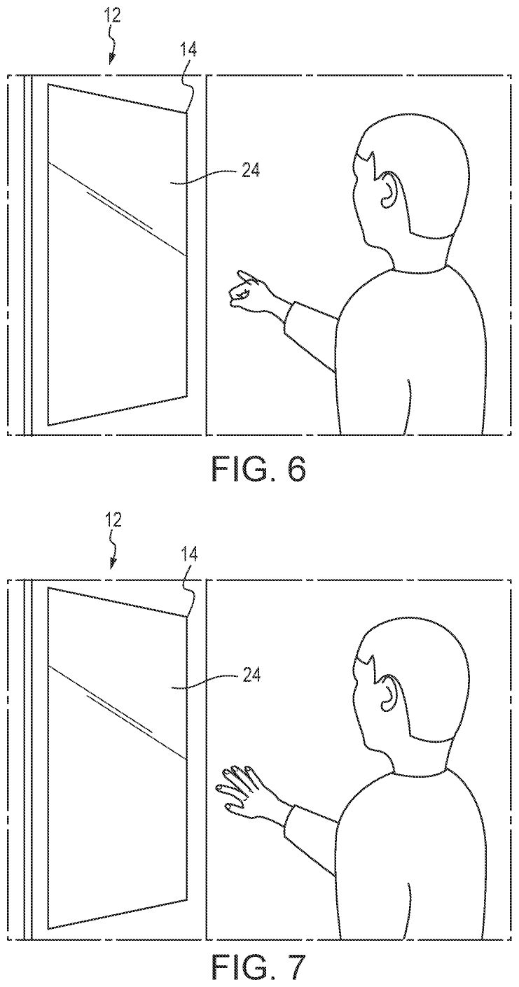

As suggested in FIG. 5, the user has elected to address the display 14 with a fist. For example, the user may intend to point with a knuckle or may intend to activate virtual buttons by contactless “pressing” with a punching action. Knuckles and/or punching actions can leave less certainty regarding the precise point of the user's hand intended for interaction with the display 14. In FIG. 6, the user has elected to address the display 14 with a little finger, while in FIG. 7, the user has elected to use a loosely spread finger arrangement.

Each of the non-limiting examples of manners of addressing the display 14 from FIGS. 4-7 indicate uncertainties that can exist regarding the precise point which the user intends to focus as the target interface element for interaction with the display 14. Additionally, such hand configuration issues can arise when the user applies an instrument, such as a stylus or pen, as the target interface element for interaction with the display 14. Accordingly, by determining the target interface element based on direct hand tracking and the additional scrutiny applied for the activation zone 22, more reliable contactless interfacing can be achieved.

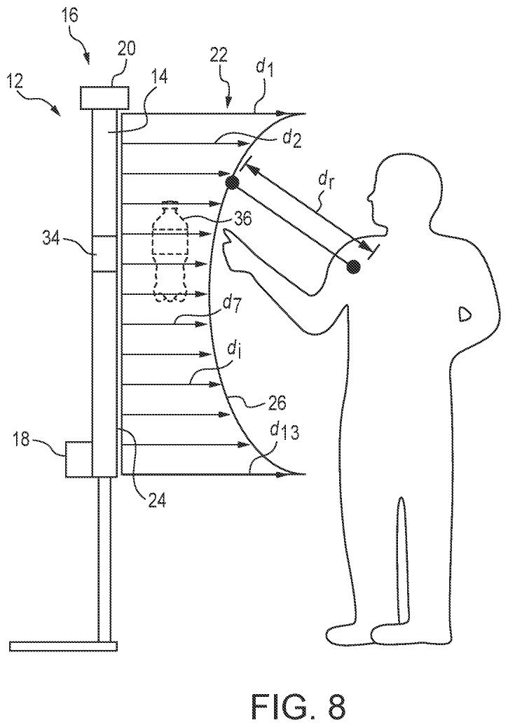

As shown in FIG. 8, the display 14 may include a holographic projector 34. The control system 18 can operate the holographic projector 34 to present holographic images, such as the beverage bottle 36, within the activation zone 22. The user can interact with the holographic images within the activation zone 22 with contactless gestures. For example, the user may swipe to rotate the 3D beverage bottle 36 and/or may grasp the beverage bottle 36 within the activation zone 22 and place the beverage bottle 36 into a virtual shopping cart on the display 14. Accordingly, the control system 18 can apply the enhanced determination of the target interface element based on direct hand tracking and the additional scrutiny applied for the activation zone 22, to provide more accurate and/or realistic interaction with the holographic images.

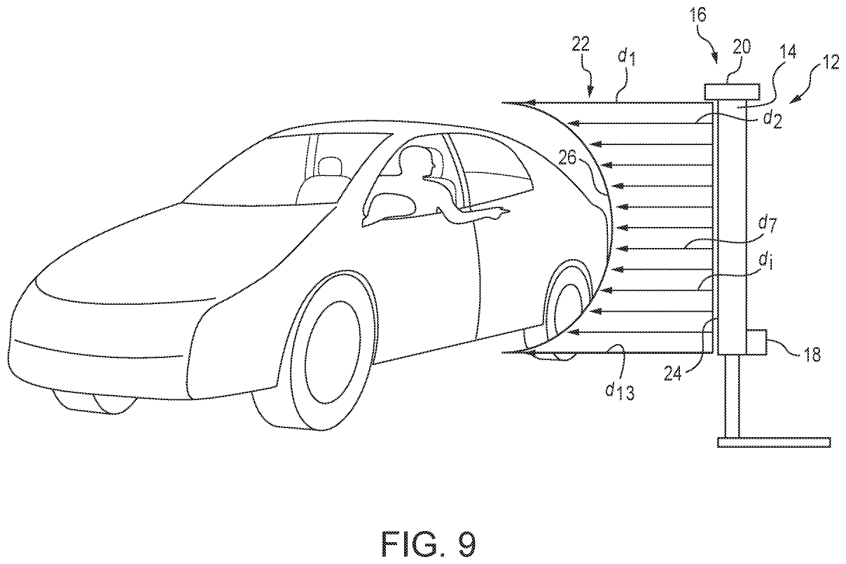

Referring now to FIG. 9, the contactless user interface system 12 is shown arranged for drive-in use. The user can operate the contactless user interface system 12 from the comfort of the vehicle. However, the comfortable reach positions for the user in the vehicle may be considerably different from those instances when the user is standing, as mentioned above. The activation zone 22 can be formed to accommodate the particular user, as discussed above, in consideration of the user's reach and/or body position such as differing body positions from various vehicle heights. Moreover, determining the target interface element based on direct hand tracking and the additional scrutiny applied for the activation zone 22 can provide more accurate and/or reliable interfacing, and particularly so in the more restricted region which can be comfortably reached from the vehicle.

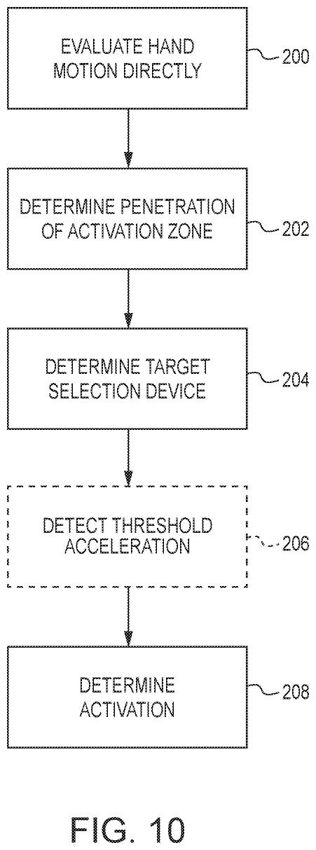

Referring now to FIG. 10, as mentioned herein, the control system 18 may determine activation of visual information of the display 14. In box 200, the sensor system 16 can conduct direct hand tracking. Direct hand tracking can be communicated with the control system 18, and/or may be performed by the sensor system 16 together with assistance by the control system 18.

In box 202, the control system 18 can determine penetration of the activation zone 22. Determining penetration may include analyzing data from the sensor system 16 to determine that the user's hand is within the activation zone 22. Determining penetration may include analyzing information from sensor system 16 to determine a user's hand configuration within the activation zone, for example, the particular position, shape, and/or arrangement of the user's hand within the activation zone 22. Although direct hand tracking and determination of penetration may be performed separately and/or in wholly or partly shared operations, operations of boxes 202 are shown distinctly, but may each be performed together, in parallel, and/or cyclically relative to other operations.

In box 204, the control system 18 can determine the target interface element based on the direct hand tracking and determination of penetration of the activation zone 22. The control system 18 can analyze data of direct hand tracking from the sensor system 16 and the determination of penetration of the activation zone 22 to determine a precise point which the user intends as the point for interfacing with the display 14. In analyzing the information, the control system 18 may compare the information of the direct hand tracking and the determination of penetration. The control system 18 may perform testing on one or more of the information of direct hand tracking and the determination of penetration, for example, by generating predictions based on the one more information and verifying such predictions to determine reliability. The control system 18 may conduct statistical analysis, machine learning, and/or may resolve ambiguities and/or disparities in considering the information of direct hand tracking and/or the determination of penetration of the activation zone 22. Accordingly, the control system 18 determines the target interface element based on direct hand tracking and penetration of the activation zone 22.

The target interface element can then be treated as the focal point for user interfacing. For example, when the user addresses the display 14 with a hand configuration which is less definitive, the control system 18 can determine the intended focal point of the user's hand for selecting and/or manipulating visual information as icons on the display, scrolling pages, and/or generally interfacing in similar manner as for touchscreen operations, yet without the need for contacting the display.

In box 206, the control system 18 may detect threshold acceleration indicating a desired interaction with display 14. In the illustrative embodiment, the control system 18 may detect threshold acceleration of the target interface element. For example, once the control system 18 has determined the target interface element as a certain part of the user's hand or instrument (e.g., pen) held by the user, the acceleration of the target interface element at or above a predetermined threshold can be applied to determine user intent for a contactless operation, such as icon selection, scrolling, etc. In some embodiments, the detection of threshold acceleration can be applied together with the direct hand tracking and the determination of penetration of the activation zone 22 to determine the target interface element, for example, by identifying the highest point of acceleration applied by the user in gesturing above a minimum threshold. The control system 18 may utilize the detection of threshold acceleration as additional indication of the focal point that the user intends for interaction with the display 14. In some embodiments, threshold detection of acceleration may include multiple predetermined thresholds applied by the control system 18, for example, one threshold acceleration detection applied in determining the target interface element and another threshold acceleration detection applied in determining activation of visual information of the display 14.

The control system 18 may actively define the predetermined threshold for threshold acceleration determination. The control system 18 may define the predetermined threshold acceleration based on the direct hand tracking and/or penetration of the activation zone 22. For example, the user's manner of addressing the display 14 may affect the threshold acceleration for indicating activation of visual information. More specifically, if the user addresses the display 14 with their palm facing upwards, the threshold acceleration indicating that the user actually intends to select an icon may be slower than if the palm is facing downwards. Similarly, the user's body position, posture, height, and/or other aspects may be considered in determining predetermined threshold acceleration. Accordingly, the control system 18 can define relevant predetermined threshold acceleration based on the user.

In box 208, the control system 18 can determine user intent for activation of visual information of the display 14 based on the determined target interface element. Activation of visual information can include any sort of interaction with the visual information of the display 14, for example, selecting, manipulating, moving, altering, moving, scrolling, zooming, focusing, and/or any other interactions with visual information of the display 14. For example, based on a determination that the target interface element is a pen held by the user's hand, the control system 18 can determine that the user has gestured for selection of a particular icon on the display 14. Accordingly, the user's gestures can be more accurately, precisely, and/or reliably determined for interfacing.

In some embodiments, the control system 18 may apply the threshold acceleration in determining activation of visual information. For example, the threshold acceleration may be applied to the target interface element determined to be a pen held by the user, e.g., within the activation zone 22. The control system 18 may determine activation upon the user's pen achieving the threshold acceleration for icon selection, scrolling, manipulation, etc. Threshold accelerations for different operations may vary.

In some embodiments, the control system 18 may determine the precise visual information for selection based on the distance between the target interface element and the display 14. For example, the control system 18 may determine the target interface element as one of the user's fingers and may determine the distance between the one of the user's fingers and the display 18, such as the distance of the target interface element normal to the surface 24 of the display 18. Based on this determined distance between the target interface element and the display 18, the control system 18 can reliably determine the particular visual information of the display 18 with which the user intends to interact. For example, based on the distance of the target interface element normal to the surface 24 of the display 14, control system 18 may determine that one icon is closest to the user's intended target selection element, and thus that icon is intended to be interacted with. In some embodiments, the control system 18 may apply the determined distance between the target interface element and the display 18 in determining the configuration of the activation zone 22, for example, to define one or more of the predetermined distances dᵢ.

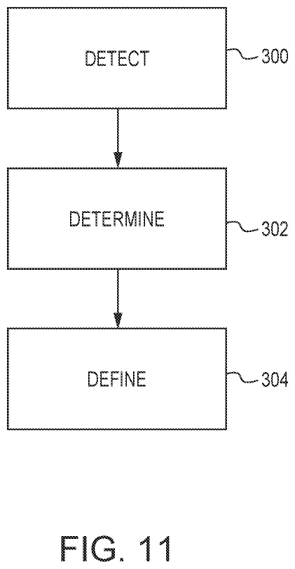

Referring now to FIG. 11, as mentioned herein, the control system 18 can define the activation zone 22. In box 300, the control system 18 can detect aspects of the user's comfortable range of motion. Such aspects can include, for example, height, stance, gait, arm length, hand dominance, posture, mobility limitations (e.g., cane, wheelchair, etc.), and/or other suitable aspects considering the user's reach. The control system 18 illustratively receives information from the sensor system 16, which may include visual, audio, and/or other information from which the aspects of the user's comfortable range of motion can be determined.

In box 302, the control system 18 can determine the definition of the activation zone 22 based on the detected aspects of the user's comfortable range of motion. The control system 18 can consider all available information, including known or pre-selected aspects of the user's comfortable range of motion to define the activation zone 22. For example, the control system 18 may consider statistical data regarding the detected or inputted age, gender, weight, season, geographic location, among other aspects of the user in determining definition of the activation zone 22.

In box 304, the control system 18 can define the activation zone 22 based on the determined definition. The control system 18 can define the activation zone 22 by executing the data analysis on the information received from the sensor system 16 concerning the defined activation zone 22. The control system 18 can actively define the activation zone 22 by conducting operations as discussed regarding boxes 300-304 in cycles to provide updated definition of the activation zone 22.

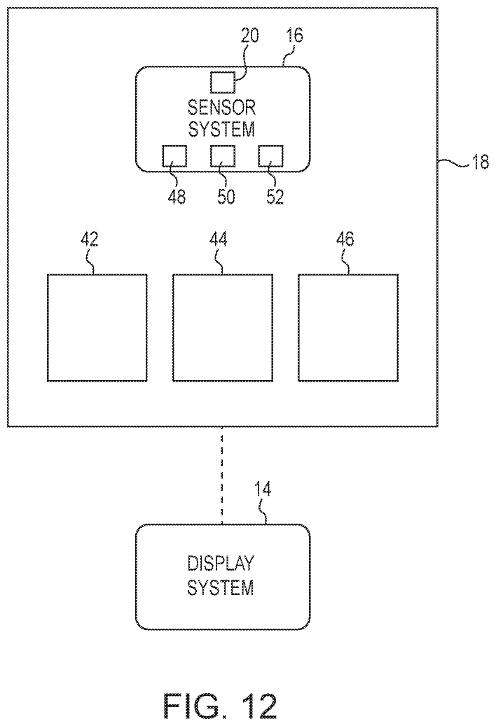

Referring to FIG. 12, the control system 18 includes a processor 42, memory 44, and communication circuitry 46 for conducting control system operations. The processor 42 executes instructions stored on memory 44, and can communicate signals with other devices and/or systems, such as the display 14, via the communication circuitry 46.

In FIG. 12, the sensor system 16 is illustratively shown formed as a part of the control system 18, but in some embodiments may be formed separately but in communication therewith. The sensor system 16 includes one or more sensors 20, processor 48, memory 50, and communication circuitry 52 for its disclosed operations. In some embodiments, the processor, memory, and/or communication circuitry of the sensor system 16 may be partly or wholly shared with the control system 18.

CENTER OF PALM MEASUREMENT REGARDING THE DETERMINATION OF THE FINGER OF INTEREST (INTERFACING WITH MULTIPLE USERS/HANDS)—User contactless interfacing can face challenges related to the particular mode of interface, e.g., manner of the hand, used to communicate with the system. For example, some users may bring multiple hands into the range of detection of the system, and/or multiple users may be positioned near the detection range of the system simultaneously, and may attempt to interact with the system simultaneously. Among other scenarios, one exemplary situation may include when a guardian with their child nearby is interfacing with the system.

In case of multiple hands: all hands may be detected as full 3D models with joints (e.g., hand, fingers) in space for every frame the application runs. Then, for each hand, the system (e.g., via program) may see (e.g., observe/detect) which fingertip is furthest removed from the center of the palm of the corresponding hand, and may identify this furthest fingertip as the pointing finger. For each pointing finger on each hand, the system may take the fingertip location and measure how far away this point is form the surface of the screen or display; this is proximity.

The system may take the fingertip position that has the closest proximity as the main finger. If at any point another hand with fingers gets closer in proximity, or a finger on that hand is further removed from the palm by stretching, the system may re-designate this finger as the primary finger. In the illustrative embodiment, this logic may run on a per-hand basis, per-finger and may be repeated, for example, at about 120 Hz, or 120 times a second. Often, there may be one hand with one pointing finger, and in exemplary instances, the sensor system may be configured to handle (e.g., gather, detect) 10 hands at the same time, including up to 50 fingers of which are 10 pointing fingers, where there is one primary finger at all times. In some instances, this may be the case unless there are no hands detected at a given time.

PAUSE TIME—In some embodiments, a pause time may be implemented to assist with managing errant communications. For example, a brief pause may be implemented to reset the system and/or prevent capturing unintended gestures. Such pauses can prevent capturing accidental double entry (“taps”).

INTERRUPTION OF PAUSE TIME—Pause time can be interrupted (even though it's just a split second), if another hand decided to interact with the screen. The same hand should be prevented to invoke an accidental click, if another hand tries to invoke a click this would be ok as it is a different intention. The pausing mechanism is there to prevent non-intentional interactions.

VIRTUAL REALITY—In one exemplary practical application, a virtual kiosk may be configured in a virtual store. A system, such as the system 12 as disclosed within U.S. Provisional Patent Application No. 63/146,195, may be implemented, e.g., one-to-one, to virtual reality for operation with a virtual screen/kiosk. Indeed, in some instances, such an implementation as a virtual store may provide advantages, such as to accuracy, speed, timing, or otherwise, over implementation as a physical kiosk. Additionally, virtual reality (VR) implementations may include screens of various shapes, and interactions in VR may be solved in different ways. For example, in VR, space and/or distance can be relative, such that a subject (user) can move, but additionally, the kiosk can move. Indeed, the subject (user) may themselves comprise one or more of the sensors, for example, of the sensor system (e.g., sensor system 16 as disclosed within U.S. Provisional Patent Application No. 63/146,195). In various implementations of virtual kiosk or virtual reality implementation of contactless user interfacing, the particular manner of modelling, sensing, and/or detecting user intent of the hand (or selection object) can provide advantages to the user and/or particular to the VR space. This can be true for many varieties of sensor location and/or type of measurement.

Within the present disclosure various hardware indicated may take various forms. Examples of suitable processors may include one or more microprocessors, integrated circuits, system-on-a-chips (SoC), among others. Examples of suitable memory, may include one or more primary storage and/or non-primary storage (e.g., secondary, tertiary, etc. storage); permanent, semi-permanent, and/or temporary storage; and/or memory storage devices including but not limited to hard drives (e.g., magnetic, solid state), optical discs (e.g., CD-ROM, DVD-ROM), RAM (e.g., DRAM, SRAM, DRDRAM), ROM (e.g., PROM, EPROM, EEPROM, Flash EEPROM), volatile, and/or non-volatile memory; among others. Communication circuitry includes components for facilitating processor operations, for example, suitable components may include transmitters, receivers, modulators, demodulator, filters, modems, analog to digital converters, operational amplifiers, and/or integrated circuits.

Clause 1. A contactless user interface system for ordering merchandise without user contact with peripherals, the system comprising: a user interface display configured for presenting visual information to the user, the visual information comprising at least one selectable merchandise option; a sensor system for capturing contactless user inputs, the sensor system comprising at least one sensor configured to capture contactless user inputs including user position and user contactless gesture, the sensor system configured to detect penetration of an activation zone as an indication that the user intends to provide contactless user input to the user interface display, wherein the sensor system is configured for direct tracking of a user's hand to directly sense the position of the user's hand in at least a portion of an area outside from the activation zone, wherein the sensor system is configured to communicate one or more user input signals indicating direct tracking of the user's hand and indicating the detected penetration of the activation zone; a control system including a processor configured to execute instructions stored on memory to govern contactless user interface system operations, the control system arranged in communication with the sensor system to receive the one or more user input signals and configured to determine a target interface element applied by the user for contactless engagement with the visual information of the user interface display, based on indication of direct tracking of the user's hand and indication of penetration of the activation zone of the one or more user input signals.

Clause 2. The system of clause 1, wherein the control system is configured to define the activation zone as a region ahead of the user interface display extending beyond a face of the user interface display by a predetermined distance.

Clause 3. The system of any preceding clause, wherein the activation zone is defined by the control system for enhanced monitoring to determine a focal point of the target interface element, wherein the focal point of target interface element is applied as a precise point of indication for user contactless activation of visual information.

Clause 4. The system of any preceding clause, wherein the focal point of the target interface element includes a point of the user's hand, or of an instrument held in the user's hand, that is closest to the user interface display within the activation zone as the precise point of indication for user contactless engagement with the visual information.

Clause 5. The system of any preceding clause, wherein the control system is configured to define the activation zone as a 3-dimensional region.

Clause 6. The system of any preceding clause, wherein the control system is configured to define the activation zone as a region projecting farther from the user interface display near at least one of a top section and a bottom section of the user interface display than in a mid-section of the display.

Clause 7. The system of any preceding clause, wherein the control system is configured to determine an acceleration of the user's hand or instrument held in the user's hand within the activation zone based on the one or more user input signals.

Clause 8. The system of any preceding clause, wherein the control system is configured to determine user intent to cause activation of visual information of the user interface display based on the determined acceleration within the activation zone.

Clause 9. The system of any preceding clause, wherein the control system is configured to determine user intent to cause activation of an area on the user interface display by comparison of the determined acceleration within the activation zone with a predetermined threshold acceleration.

Clause 10. The system of any preceding clause, wherein the control system is configured to determine the predetermined threshold acceleration based on at least one of penetration of the activation zone and direct tracking of the user's hand based on the user input signal.

Clause 11. The system of any preceding clause, wherein penetration of the user's hand within the activation zone includes at least one of depth of penetration into the activation zone and a hand configuration of the user.

Clause 12. The system of any preceding clause, wherein the hand configuration of the user includes the number of fingers of the user's hand extended to indicate the visual information for activation on the user interface display.

Clause 13. The system of any preceding clause, wherein depth of penetration includes distance between the user interface display and a lead digit of the user's hand.

Clause 14. The system of any preceding clause, wherein the control system is configured to determine that the lead digit of the user's hand is the closest finger to the user interface display.

Clause 15. The system of any preceding clause, wherein the control system is configured to determine that the lead digit of the user's hand is the not closest finger to the user interface display, based on the user's hand configuration within the activation zone.

Clause 16. The system of any preceding clause, wherein the control system is configured to define the activation zone based on information gathered by the sensor system regarding the user.

Clause 17. The system of any preceding clause, wherein the control system is configured to actively define the activation zone.

Clause 18. The system of any preceding clause, wherein the control system is configured to actively define the activation zone based on information gathered by the sensor system regarding the user.

Clause 19. A method of contactless user interfacing for ordering merchandise without user contact with peripherals, the method comprising: presenting visual information to a user via a user interface display, the visual information comprising at least one selectable merchandise option; capturing contactless user inputs including user position and user contactless gesture, via a sensor system, wherein capturing contactless user inputs includes detecting penetration of an activation zone as an indication that the user intends to provide contactless user input to the user interface display, and directly tracking a user's hand to directly sense the position of the user's hand in at least a portion of an area outside from the activation zone, and communicating one or more user input signals indicating direct tracking of the user's hand and indicating the detected penetration of the activation zone; and determining, via a control system, a target interface element applied by the user for contactless engagement with the visual information of the user interface display, based on indication of direct tracking of the user's hand and indication of penetration of the activation zone of the one or more user input signals.

Clause 20. The method of clause 19, wherein capturing contactless gestures includes defining the activation zone as a region ahead of the user interface display extending beyond a face of the user interface display by a predetermined distance.

Clause 21. The method of any preceding clause, wherein the activation zone is defined by the control system for enhanced monitoring to determine a focal point of the target interface element, wherein the focal point of target interface element is applied as a precise point of indication for user contactless activation of visual information.

Clause 22. The method of any preceding clause, wherein the focal point of the target interface element includes a point of the user's hand, or of an instrument held in the user's hand, that is closest to the user interface display within the activation zone as the precise point of indication for user contactless engagement with the visual information.

Clause 23. The method of any preceding clause, wherein the activation zone is defined as a 3-dimensional region.

Clause 24. The method of any preceding clause, wherein defining the activation zone includes defining a region projecting farther from the user interface display near at least one of a top section and a bottom section of the user interface display than in a mid-section of the display.

Clause 25. The method of any preceding clause, wherein determining a target selection device includes determining an acceleration of the user's hand or instrument held in the user's hand within the activation zone based on the one or more user input signals.

Clause 26. The method of any preceding clause, wherein determining a target selection device includes determining user intent to cause activation of visual information of the user interface display based on the determined acceleration within the activation zone.

Clause 27. The method of any preceding clause, wherein determining user intent to cause activation includes determining intent to cause activation of an area on the user interface display by comparison of the determined acceleration within the activation zone with a predetermined threshold acceleration.

Clause 28. The method of any preceding clause, wherein determining intent to cause activation includes determining the predetermined threshold acceleration based on at least one of penetration of the activation zone and direct tracking of the user's hand based on the user input signal.

Clause 29. The method of any preceding clause, wherein penetration of the user's hand within the activation zone includes at least one of depth of penetration into the activation zone and a hand configuration of the user.

Clause 30. The method of any preceding clause, wherein the hand configuration of the user includes the number of fingers of the user's hand extended to indicate the visual information for activation on the user interface display.

Clause 31. The method of any preceding clause, wherein depth of penetration includes distance between the user interface display and a lead digit of the user's hand.

Clause 32. The method of any preceding clause, wherein determining a target selection device includes determining that the lead digit of the user's hand is the closest finger to the user interface display.

Clause 33. The method of any preceding clause, wherein determining a target selection device includes determining that the lead digit of the user's hand is the not closest finger to the user interface display, based on the user's hand configuration within the activation zone.

Clause 34. The method of any preceding clause, wherein capturing contactless gestures includes defining the activation zone based on information gathered by the sensor system regarding the user.

Clause 35. The method of any preceding clause, wherein defining the activation zone includes actively define the activation zone.

Clause 36. The method of any preceding clause, wherein actively defining the activation zone includes actively defining the activation zone based on information gathered by the sensor system regarding the user.

Clause 37. A contactless user interface system for selecting merchandise without user contact with peripherals, the system comprising: a user interface display configured for presenting visual information to the user, the visual information comprising at least one selectable merchandise option; a sensor system for capturing contactless user inputs, the sensor system comprising at least one sensor configured to capture contactless user inputs including user position and user contactless gesture; a control system including a processor configured to execute instructions stored on memory to govern contactless user interface system operations, the control system arranged in communication with the sensor system to receive the one or more user input signals for determining user inputs as commands.

Clause 38. The contactless user interface system of clause 37, wherein the control system is configured to determine which fingertip of a user's hand is furthest removed from the center of the palm of the corresponding hand, and to identify the determined fingertip as a target interface element.

Clause 39. The contactless user interface system of any preceding clause, wherein in response to capture of multiple user hands close in time with each other by the sensor system, the control system is configured to determine which one of the multiple user hands corresponds with a determined fingertip that is closest to the user interface display.

Clause 40. The contactless user interface system of any preceding clause, wherein in response to determination that one determined fingertip of one corresponding hand is the closest to the user interface display of multiple hands, the control system is configured to designate the one determined fingertip as the primary target interface element.

Clause 41. The contactless user interface system of any preceding clause, wherein in response to determination that another determined fingertip of one corresponding hand is newly the closest to the user interface display of multiple hands, the control system is configured to re-designate the another determined fingertip as the primary target interface element.

Clause 42. The contactless user interface system of any preceding clause, wherein re-designation is undertaken only after at least a predetermined time pause from a previous designation.

Clause 43. The contactless user interface system of any preceding clause, wherein activation of a command by a primary target interface element is undertaken only after a predetermined time pause from a previous command to avoid unintended activations.

Clause 44. The contactless user interface system of any preceding clause, wherein activation of a command by a primary target interface element of a corresponding hand is undertaken only after a predetermined time pause from a previous command to avoid unintended activations from the same corresponding hand.

Clause 45. The contactless user interface system of any preceding clause, wherein activation of a command by a primary target interface element of another corresponding hand that is re-designated is undertaken without the predetermined time pause.

Clause 46. The contactless user interface system of any preceding clause, wherein activation of a command by a primary target interface element of a corresponding hand is undertaken only after a predetermined time pause from a previous command to avoid unintended activations from the same corresponding hand.

Clause 47. The contactless user interface system of any preceding clause, wherein activation of a command by a primary target interface element of another corresponding hand that is re-designated is undertaken without the predetermined time pause.

Clause 48. The contactless user interface system of any preceding clause, implemented as a portion of a virtual kiosk.

Clause 49. A virtual kiosk comprising: a contactless user interface system for selecting merchandise without user contact with peripherals, the system comprising: a user interface display configured for presenting virtual visual information to the user, the virtual visual information comprising at least one selectable merchandise option; a sensor system for capturing contactless user inputs, the sensor system comprising at least one sensor configured to capture contactless user inputs including user position and user contactless gesture, the sensor system configured to detect penetration of an activation zone as an indication that the user intends to provide contactless user input to the user interface display, wherein the sensor system is configured for direct tracking of a user's hand to directly sense the position of the user's hand in at least a portion of an area outside from the activation zone, wherein the sensor system is configured to communicate one or more user input signals indicating direct tracking of the user's hand and indicating the detected penetration of the activation zone; a control system including a processor configured to execute instructions stored on memory to govern contactless user interface system operations, the control system arranged in communication with the sensor system to receive the one or more user input signals and configured to determine a target interface element applied by the user for contactless engagement with the visual information of the user interface display, based on indication of direct tracking of the user's hand and indication of penetration of the activation zone of the one or more user input signals.

Clause 50. The virtual kiosk of clause 49, wherein the activation zone is defined as a virtual zone.

Clause 51. The virtual kiosk of any preceding clause, wherein the activation zone is defined as a physical zone.

Clause 52. The virtual kiosk of any preceding clause, wherein the user's hand is defined as a virtual hand.

Clause 53. The virtual kiosk of any preceding clause, wherein the user's hand is defined as a physical hand.

Clause 54. The virtual kiosk of any preceding clause, wherein at least one of the sensor system and the control system is a virtual system.

Clause 55. The virtual kiosk of any preceding clause, wherein at least one of the sensor system and the control system is a physical system.

Clause 56. The virtual kiosk of any preceding clause, wherein the user interface display is a virtual display.

Clause 57. The virtual kiosk of any preceding clause, wherein the user interface display is a physical display.

While certain illustrative embodiments have been described in detail in the figures and the foregoing description, such an illustration and description is to be considered as exemplary and not restrictive in character, it being understood that only illustrative embodiments have been shown and described and that all changes and modifications that come within the spirit of the disclosure are desired to be protected. There are a plurality of advantages of the present disclosure arising from the various features of the methods, systems, and articles described herein. It will be noted that alternative embodiments of the methods, systems, and articles of the present disclosure may not include all of the features described yet still benefit from at least some of the advantages of such features. Those of ordinary skill in the art may readily devise their own implementations of the methods, systems, and articles that incorporate one or more of the features of the present disclosure.

We claim:

1. A contactless user interface system for ordering merchandise without user contact with peripherals, the system comprising:
a user interface display configured for presenting visual information to the user, the visual information comprising at least one selectable merchandise option;
a sensor system for capturing contactless user inputs, the sensor system comprising at least one sensor configured to capture contactless user inputs including user position and user contactless gesture, the sensor system configured to detect penetration of an activation zone as an indication that the user intends to provide contactless user input to the user interface display, wherein the sensor system is configured for direct tracking of a user's hand to directly sense the position of the user's hand in at least a portion of an area outside from the activation zone, wherein the sensor system is configured to communicate one or more user input signals indicating direct tracking of the user's hand and indicating the detected penetration of the activation zone;
a control system including a processor configured to execute instructions stored on memory to govern contactless user interface system operations, the control system arranged in communication with the sensor system to receive the one or more user input signals and configured to determine a target interface element applied by the user for contactless engagement with the visual information of the user interface display, based on indication of direct tracking of the user's hand and indication of penetration of the activation zone of the one or more user input signals.

2. The system of claim 1, wherein the control system is configured to define the activation zone as a region ahead of the user interface display extending beyond a face of the user interface display by a predetermined distance.

3. The system of claim 2, wherein the activation zone is defined by the control system for enhanced monitoring to determine a focal point of the target interface element, wherein the focal point of target interface element is applied as a precise point of indication for user contactless activation of visual information.

4. The system of claim 3, wherein the focal point of the target interface element includes a point of the user's hand, or of an instrument held in the user's hand, that is closest to the user interface display within the activation zone as the precise point of indication for user contactless engagement with the visual information.

5. The system of claim 2, wherein the control system is configured to define the activation zone as a 3-dimensional region.

6. The system of claim 2, wherein the control system is configured to define the activation zone as a region projecting farther from the user interface display near at least one of a top section and a bottom section of the user interface display than in a mid-section of the display.

7. The system of claim 1, wherein the control system is configured to determine an acceleration of the user's hand or instrument held in the user's hand within the activation zone based on the one or more user input signals.

8. The system of claim 7, wherein the control system is configured to determine user intent to cause activation of visual information of the user interface display based on the determined acceleration within the activation zone.

9. The system of claim 8, wherein the control system is configured to determine user intent to cause activation of an area on the user interface display by comparison of the determined acceleration within the activation zone with a predetermined threshold acceleration.

10. The system of claim 9, wherein the control system is configured to determine the predetermined threshold acceleration based on at least one of penetration of the activation zone and direct tracking of the user's hand based on the user input signal.

11. The system of claim 10, wherein penetration of the user's hand within the activation zone includes at least one of depth of penetration into the activation zone and a hand configuration of the user.

12. The system of claim 11, wherein the hand configuration of the user includes the number of fingers of the user's hand extended to indicate the visual information for activation on the user interface display.

13. The system of claim 11, wherein depth of penetration includes distance between the user interface display and a lead digit of the user's hand.

14. The system of claim 13, wherein the control system is configured to determine that the lead digit of the user's hand is the closest finger to the user interface display.

15. The system of claim 13, wherein the control system is configured to determine that the lead digit of the user's hand is the not closest finger to the user interface display, based on the user's hand configuration within the activation zone.

16. The system of claim 1, wherein the control system is configured to define the activation zone based on information gathered by the sensor system regarding the user.

17. The system of claim 1, wherein the control system is configured to actively define the activation zone.

18. The system of claim 17, wherein the control system is configured to actively define the activation zone based on information gathered by the sensor system regarding the user.

19. A method of contactless user interfacing for ordering merchandise without user contact with peripherals, the method comprising:
presenting visual information to a user via a user interface display, the visual information comprising at least one selectable merchandise option;
capturing contactless user inputs including user position and user contactless gesture, via a sensor system, wherein capturing contactless user inputs includes detecting penetration of an activation zone as an indication that the user intends to provide contactless user input to the user interface display, and directly tracking a user's hand to directly sense the position of the user's hand in at least a portion of an area outside from the activation zone, and communicating one or more user input signals indicating direct tracking of the user's hand and indicating the detected penetration of the activation zone; and
determining, via a control system, a target interface element applied by the user for contactless engagement with the visual information of the user interface display, based on indication of direct tracking of the user's hand and indication of penetration of the activation zone of the one or more user input signals.

20. The method of claim 19, wherein capturing contactless gestures includes defining the activation zone as a region ahead of the user interface display extending beyond a face of the user interface display by a predetermined distance.

21. The method of claim 20, wherein the activation zone is defined by the control system for enhanced monitoring to determine a focal point of the target interface element, wherein the focal point of target interface element is applied as a precise point of indication for user contactless activation of visual information.

22. The method of claim 21, wherein the focal point of the target interface element includes a point of the user's hand, or of an instrument held in the user's hand, that is closest to the user interface display within the activation zone as the precise point of indication for user contactless engagement with the visual information.

23. The method of claim 20, wherein the activation zone is defined as a 3-dimensional region.

24. The method of claim 20, wherein defining the activation zone includes defining a region projecting farther from the user interface display near at least one of a top section and a bottom section of the user interface display than in a mid-section of the display.

25. The method of claim 19, wherein determining a target selection device includes determining an acceleration of the user's hand or instrument held in the user's hand within the activation zone based on the one or more user input signals.

26. The method of claim 25, wherein determining a target selection device includes determining user intent to cause activation of visual information of the user interface display based on the determined acceleration within the activation zone.

27. The method of claim 26, wherein determining user intent to cause activation includes determining intent to cause activation of an area on the user interface display by comparison of the determined acceleration within the activation zone with a predetermined threshold acceleration.

28. The method of claim 27, wherein determining intent to cause activation includes determining the predetermined threshold acceleration based on at least one of penetration of the activation zone and direct tracking of the user's hand based on the user input signal.

29. The method of claim 28, wherein penetration of the user's hand within the activation zone includes at least one of depth of penetration into the activation zone and a hand configuration of the user.

30. The method of claim 29, wherein the hand configuration of the user includes the number of fingers of the user's hand extended to indicate the visual information for activation on the user interface display.

31. The method of claim 29, wherein depth of penetration includes distance between the user interface display and a lead digit of the user's hand.

32. The method of claim 31, wherein determining a target selection device includes determining that the lead digit of the user's hand is the closest finger to the user interface display.

33. The method of claim 31, wherein determining a target selection device includes determining that the lead digit of the user's hand is the not closest finger to the user interface display, based on the user's hand configuration within the activation zone.

34. The method of claim 19, wherein capturing contactless gestures includes defining the activation zone based on information gathered by the sensor system regarding the user.

35. The method of claim 34, wherein defining the activation zone includes actively define the activation zone.

36. The method of claim 35, wherein actively defining the activation zone includes actively defining the activation zone based on information gathered by the sensor system regarding the user.
